(19) United States
(12) Patent Application Publication
(10) Pub. No.: US 2009/0188043 A1
(43) Pub. Date: Jul. 30, 2009

(54) Graduated Set of Pillows

(76) Inventor: Perry J. Kirch, Holly Springs, NC (US)

Correspondence Address: COATS & BENNETT, PLLC, 1400 Crescent Green, Suite 300, Cary, NC, 27518, US

(21) Appl. No.: 12/354,187

(22) Filed: Jan. 15, 2009

Related U.S. Application Data
(60) Provisional application No. 61/023,504, filed on Jan. 25, 2008.

(51) Int. Cl. A47G 9/10; A47G 9/02; B23P 11/02

(52) U.S. Cl. 5/643; 5/636; 5/490; 29/451

(57) ABSTRACT

A graduated set of pillows includes a plurality of three or more pillows. Each pillow is configured for a particular range of human physiological development and has a plurality of critical dimensions targeting proper postural support of persons in such range. For each critical dimension, a first pillow has a minimum dimension and a last pillow has a maximum dimension. The other pillows in the set have distinct dimensions that form graduated increments in the critical dimension over the set from the minimum dimension to the maximum dimension. Specific magnitudes of these critical dimensions may depend on the height, weight, head circumference, length of vertebral column, or neck circumference of an average person within a particular age range, for example. By providing such a graduated transition in each critical dimension, the set of pillows provides proper postural support for the gradually changing anatomical characteristics of developing persons.

This application claims priority under 35 U.S.C. §119(e) from the U.S. Provisional Patent Application Ser. No. 61/023,504, which was filed on 25 Jan. 2008 and entitled “Columns Graduated 4 Stage Sleep System.”

### TECHNICAL FIELD

The present invention generally relates to methods and apparatus for orthopedic/chiropractic pillows, and particularly relates to a graduated set of pillows configured for different ranges of human physiological development.

### BACKGROUND

Improper postural support during sleep causes positional stress on the spine. Such improper support often results from a mismatch between pillow dimensions and the specific anatomical characteristics of a person. Spinal dimensions and curvatures are roughly similar for persons in the same stage of physiological development. In recognition of these broad-based similarities, pillow manufacturers tend to offer limited sizes of pillows.

At best, a given pillow manufacturer might offer a smaller pillow for children and a larger pillow for adults. This is not to say that pillows are not available in various sizes, but rather to say that pillow sizing against particular stages of physiological development is known only in terms of gross quantization of physiological development intervals, e.g., child versus adult. However, proper spinal support during sleep is a key aspect of healthy childhood development, and the significant changes in physiology occurring during a child's developmental years are not adequately addressed by conventional pillows.

### SUMMARY

A graduated set of pillows as taught herein advantageously provides proper postural support for a person over different ranges of human physiological development. The graduated set of pillows comprises a plurality of three or more pillows. The set addresses the gradually changing anatomical characteristics of developing persons through the configuration of each pillow in the set for a particular range of human physiological development.

Each pillow in the set has a plurality of critical dimensions targeting the proper postural support of persons in a corresponding range of human physiological development. These critical dimensions may relate to, for example, the dimensions of pillow surfaces that provide cranial support or spinal support. Each critical dimension of a first pillow configured for a first range of human physiological development is smaller than each corresponding critical dimension of other pillows in the set. Likewise, each critical dimension of a last pillow configured for a last range of human physiological development is larger than each corresponding critical dimension of other pillows in the set. (Here, “last range” is a last range within the ranges addressed by the pillow set, but it may not be the last range of actual human physiological development.)

With respect to each critical dimension, therefore, the first pillow has a minimum dimension, while the last pillow has a maximum dimension. The other pillows in the set have distinct dimensions between such minimum and maximum that form graduated increments in the critical dimension over the set from the minimum dimension to the maximum dimension. In a preferred embodiment, each of the graduated increments increases a critical dimension over the set by an approximately constant value so that the graduated transition occurs evenly across the set.

Specific magnitudes of these critical dimensions may depend on at least one of the height, weight, head size (e.g., head circumference), length of vertebral column, and neck circumference of an average person within a particular range of human physiological development. Indeed, the critical dimensions presented herein derive from extensive anatomical study of many persons in various ranges of development. Furthermore, the particular ranges of development over which to take such averages may correlate with various developmental indicators, such as age. In a preferred embodiment, for example, the graduated set of pillows comprises four pillows, each pillow configured for a different one of age ranges from 2-4, 5-7, 8-11, and 12-15. Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a perspective view of a graduated set of pillows of the present invention.

FIG. 2 is a cross-sectional view of the graduated set of pillows taken along line II-II in FIG. 1.

FIG. 3 is a perspective view of a graduated set of pillows illustrating the configuration of each pillow for a particular range of ages.

FIG. 4 is a cross-sectional view of the graduated set of pillows taken along line IV-IV of FIG. 3.

FIG. 5 is a logical flow diagram illustrating a method of manufacturing a graduated set of pillows of the present invention.

FIG. 6 is a table of example magnitudes of the critical dimensions of the graduated set of pillows, such as shown in FIGS. 3 and 4

### DETAILED DESCRIPTION

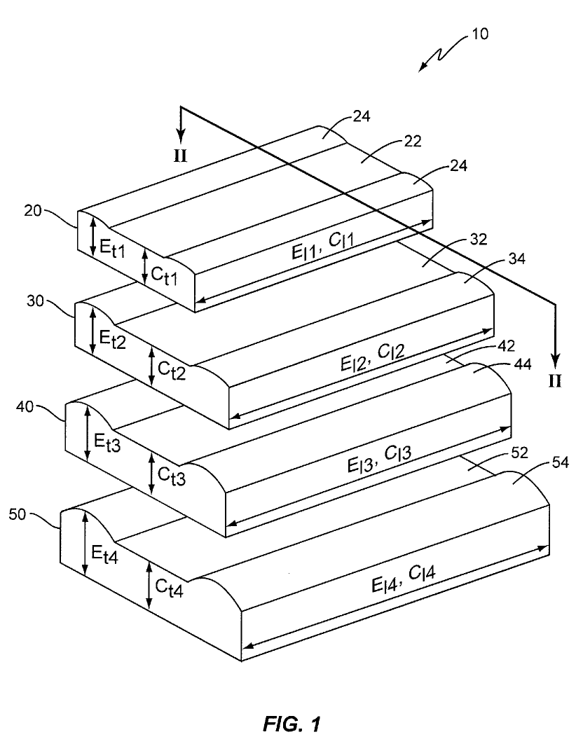

FIG. 1 illustrates a graduated set of pillows 10 comprising a plurality of pillows 20, 30, 40, and 50. Each pillow 20, 30, 40, and 50 is configured for a particular range of human physiological development, including configuration for proper postural support of persons in that range. A first pillow 20, for example, is configured for a first range of human physiological development, while a last pillow 50 is configured for a last range of human physiological development. The other pillows in the set 30 and 40 are configured for ranges in between this first and last range in order to provide a graduated transition from the first pillow 20 to the last pillow 50.

Such configuration includes each pillow 20, 30, 40, and 50 having a plurality of critical dimensions (e.g., length, width, thickness) targeting the proper postural support of persons in a corresponding range of human physiological development. As the first pillow 20 is configured for the first range, each critical dimension of the first pillow 20 is smaller than each corresponding critical dimension of other pillows 30, 40, and 50 in the set 10. Likewise, as the last pillow 50 is configured for the last range, each critical dimension of the last pillow 50 is larger than each corresponding critical dimension of other pillows 20, 30, and 40 in the set 10. With respect to each critical dimension, therefore, the first pillow 20 has a minimum dimension, while the last pillow 50 has a maximum dimension. The other pillows 30 and 40 in the set 10 have distinct dimensions between such minimum and maximum that form graduated increments in the critical dimension over the set 10 from the minimum dimension to the maximum dimension. These graduated increments enable a graduated transition from the minimum dimensions of the first pillow 20 to the maximum dimensions of the last pillow 50.

In a preferred embodiment, each of the graduated increments increases a critical dimension over the set 10 by an approximately constant value so that the graduated transition occurs evenly across the set 10. By minimizing the variation of a critical dimension over the set 10, the ability of the set 10 to provide proper postural support for a person over all ranges of human physiological development is maximized.

Albeit at a potential cost increase, this ability may also be enhanced by including additional pillows in the set between the first pillow 20 and the last pillow 50. Assuming the first pillow 20 and the last pillow 50 have given minimum and maximum dimensions, for example, increasing the number of other pillows in the graduated set 10 decreases the variation of a critical dimension over the set 10. Of course, including only one pillow in the set between the first pillow 20 and the last pillow 50 at least provides a minimal level of gradation. Thus while this preferred embodiment illustrates a plurality of four pillows 20, 30, 40, and 50, those skilled in the art will readily appreciate that the present invention may include a plurality of three or more pillows.

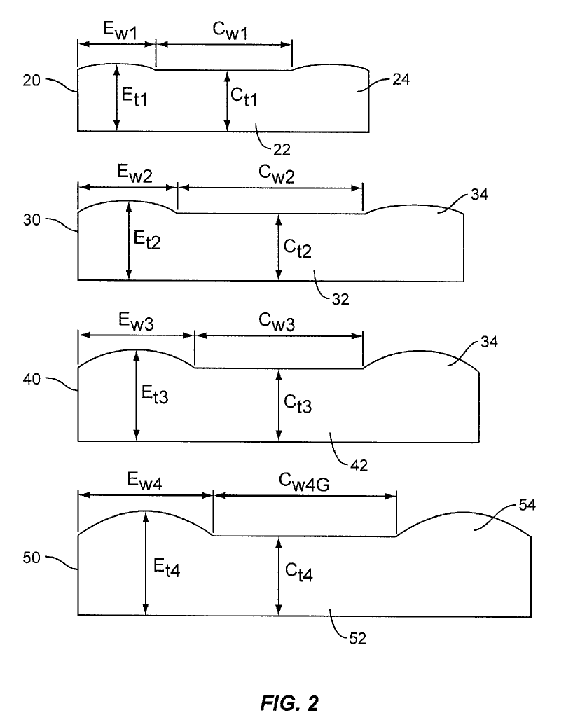

Those skilled in the art will also readily appreciate that each pillow 20, 30, 40, and 50 may have any number or types of critical dimensions depending on the anatomical characteristics and the range of human physiological development targeted by a particular pillow design. As a non-limiting example, therefore, FIGS. 1 and 2 illustrate a graduated set of pillows 10 designed so that each pillow 20, 30, 40, and 50 has a central section 22, 32, 42, and 52 for cranial support and at least one end section 24, 34, 44, and 54 adjacent thereto for spinal support. The central section 22, 32, 42, and 52 has a substantially flat upper surface for such cranial support and the end section 24, 34, 44, and 54 has a substantially arcuate upper surface for such spinal support. With this pillow design, each pillow 20, 30, 40, and 50 has critical dimensions of central section thickness C_{t1,2,3,4}, end section thickness E_{t1,2,3,4}, central section length C_{t1,2,3,4}, and end section length E_{t1,2,3,4}. More appropriately shown in FIG. 2's cross-sectional view taken along the line II-II, each pillow 20, 30, 40, and 50 also has critical dimensions of central section width C_{w1,2,3,4}, and end section width E_{w1,2,3,4}.

Consistent with the above description, all critical dimensions of the first pillow 20 (Cₜ₁, Eₜ₁, C_{I1}, E_{I1}, C_{w1} and E_{w1}) are smaller than each corresponding critical dimension of the other pillows 30, 40, and 50 (C_{t2,3,4}, E_{t2,3,4}, C_{I2,3,4}, E_{I2,3,4}, C_{w2,3,4}, and E_{w2,3,4}). Likewise, all critical dimensions of the last pillow 50 (Cₜ₄, Eₜ₄, C_{I4}, E_{I4}, C_{w4} and E_{w4}) are larger than each corresponding critical dimension of the other pillows 20, 30, and 40 (C_{t1,2,3}, E_{t1,2,3}, C_{I1,2,3}, E_{I1,2,3}, C_{w1,2,3}, and E_{w1,2,3}). With respect to each critical dimension, such as central section thickness for example, the first pillow 20 has a minimum dimension Cₜ₁, while the last pillow 50 has a maximum dimension Cₜ₄. The other pillows 30 and 40 in the set 10 have distinct dimensions Cₜ₂ and Cₜ₃ between such minimum Cₜ₁ and maximum Cₜ₄ that form graduated increments in the critical dimension over the set 10 from the minimum dimension Cₜ₁ to the maximum dimension Cₜ₄.

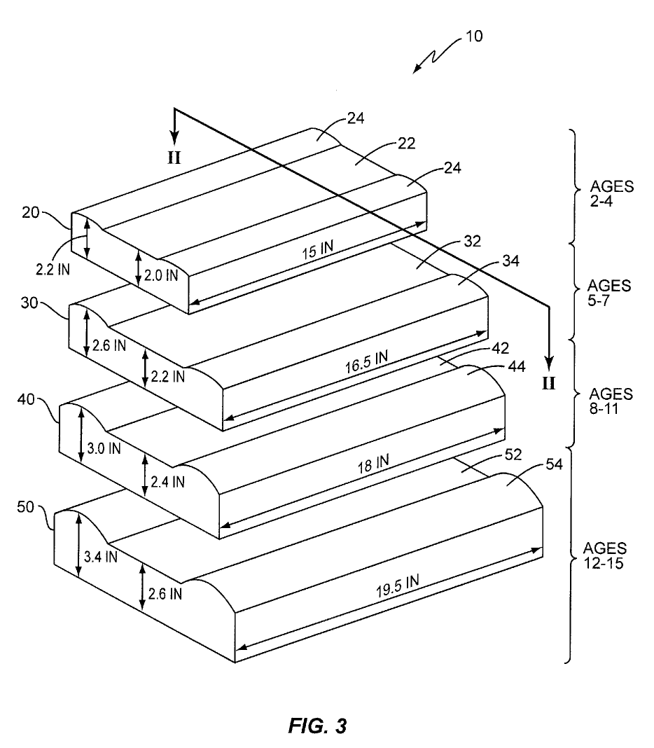

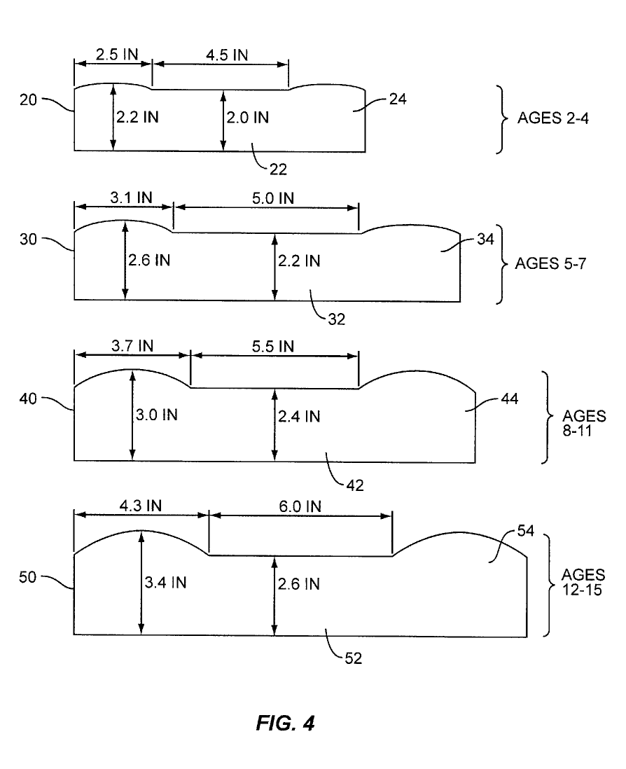

More particularly, specific magnitudes of critical dimensions such as these that target proper cranial and neck support may depend on at least one of the height, weight, head circumference, length of vertebral column, and neck circumference of an average person within a particular range of human physiological development. Such average measurements include, for instance, the height from an average person's shoulder to the top of that person's head and the height of an average person's cervical spine consisting of the top seven vertebrae C1-C7. Furthermore, the particular ranges of human physiological development over which to take such averages may correlate with various developmental indicators, such as age. Indeed, the critical dimensions presented herein derive from extensive anatomical study of these averages for persons in various age ranges. FIGS. 3 and 4, for example, illustrate the magnitudes of the above-described critical dimensions for a graduated set of pillows 10 configured for different ranges of ages, according to these empirically determined norms.

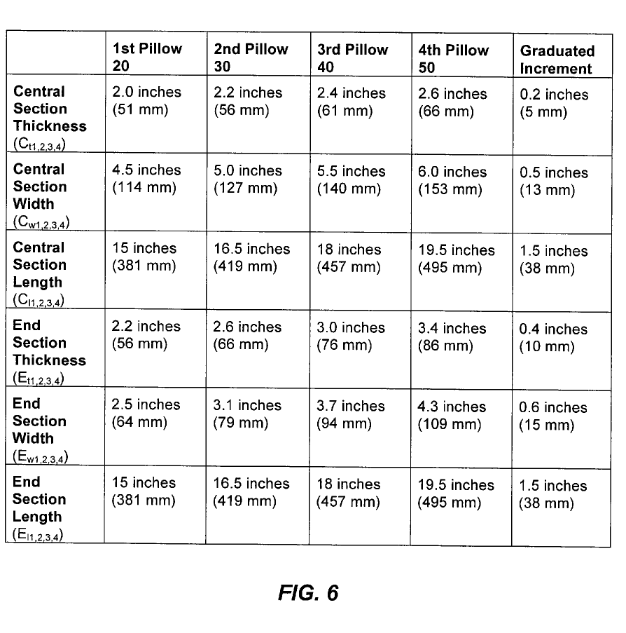

In FIGS. 3 and 4, the first pillow 20 is configured for a range of ages from 2 to 4, the second pillow 30 is configured for a range of ages from 5 to 7, the third pillow 40 is configured for a range of ages from 8 to 11, and the last pillow is configured for a range of ages from 12 to 15. Each pillow 20, 30, 40, and 50 has critical dimensions that enable a 2 year old to transition from the first pillow 20 over graduated increments to the last pillow 50 when he or she reaches the age of 12. Specifically, the first pillow 20 has a central section thickness Cₜ₁ of approximately 2.0 inches (51 mm) which is smaller than the central section thickness C_{t2,3,4}of the other pillows 30, 40, and 50. The last pillow 50 has a central section thickness Cₜ₄ of approximately 2.6 inches (66 mm) which is larger than the central section thickness C_{t1,2,3} of the other pillows 20, 30, and 40. The other pillows 30 and 40 have distinct dimensions Cₜ₂of approximately 2.2 inches (56 mm) and Cₜ₃ of approximately 2.4 inches (61 mm) that form graduated increments of approximately 0.2 inches (5 mm) in the central section thickness over the set 10 from the minimum dimension of 2.0 inches (51 mm) to the maximum dimension of 2.6 inches (66 mm). The remaining critical dimensions of the pillows 20, 30, 40, and 50 form similar graduated increments over the set 10. FIG. 6 illustrates a table of example magnitudes of the critical dimensions of the graduated set of pillows, such as shown in FIGS. 3 and 4.

It should be noted, however, that the graduated set of pillows 10 is not limited to the above empirically measured magnitudes. Nor is the graduated set of pillows 10 limited to the configuration for particular ranges of ages. Rather, the graduated set of pillows 10 may also be configured for persons having the same human physiological development, but different ages. A pillow 30, for example, may be configured for both children ranging in age from 8 to 11, as well as small framed adults having the same physiological development thereof.

It should also be noted that the magnitude of the above-described critical dimensions may require adjusting based upon the material composition of each pillow 20, 30, 40, and 50. In one embodiment, each pillow 20, 30, 40, and 50 comprises viscoelastic memory foam, preferably having a density of 4 pounds. To provide proper postural support in such a case, the critical dimensions of each pillow 20, 30, 40, and 50 is dependent on the compression of viscoelastic memory foam of an average person within a particular range of human physiological development.

In addition to configuring the material composition of each pillow 20, 30, 40, and 50 for a particular range of human physiological development, each pillow 20, 30, 40, and 50 may be configured with a dust mite resistant cover that is treated with an antimicrobial technology. The dust mite resistant (and, advantageously, fluid resistant) cover may comprise, for example, a zippered polyester fabric laminated with polyurethane to form a barrier. Thereafter treating the cover with an antimicrobial technology, such as Aegis Microbe Shield®, provides protection against odor, staining, and deterioration caused by bacteria, fungus, and other microorganisms.

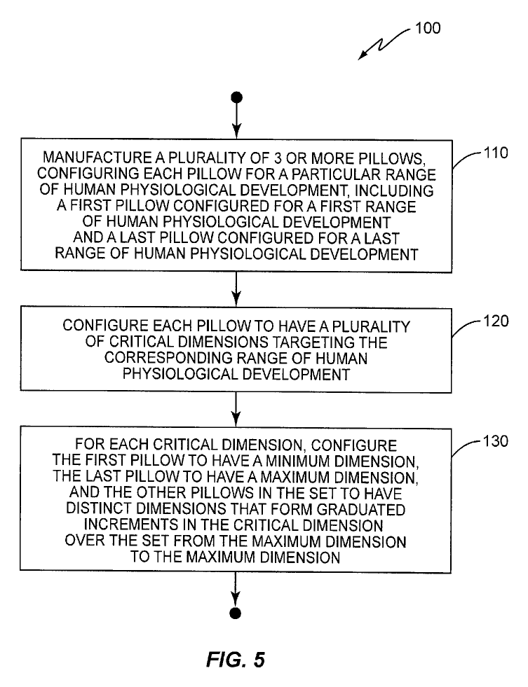

Irrespective of such additional features of the graduated set of pillows 10, FIG. 5 illustrates a method 100 of manufacturing the graduated set of pillows 10. Such method 100 comprises manufacturing a plurality of three or more pillows and configuring each pillow 20, 30, 40, and 50 for a particular range of human physiological development (Block 110). The manufacturing includes, for example, manufacturing a first pillow 20 configured for a first range of human physiological development and a last pillow 50 configured for a last range of human physiological development. Manufacturing continues by configuring each pillow 20, 30, 40, and 50 to have a plurality of critical dimensions targeting the corresponding range of human physiological development (Block 120). For each critical dimension, though, manufacturing includes configuring the first pillow 20 to have a minimum dimension, the last pillow 50 to have a maximum dimension, and the other pillows 30 and 40 in the set 10 to have distinct dimensions that form graduated increments in the critical dimension over the set 10 from the minimum dimension to the maximum dimension (Block 130).

With the above and other points of variation and implementation flexibility in mind, those skilled in the art will appreciate that the present invention is not limited by the foregoing discussion or by the accompanying drawings. Indeed, the present invention is limited only by the following claims and their legal equivalents.

What is claimed is:

1. A graduated set of pillows comprising:
a plurality of three or more pillows, each pillow configured for a particular range of human physiological development, including a first pillow configured for a first range of human physiological development and a last pillow configured for a last range of human physiological development;
each pillow having a plurality of critical dimensions targeting the corresponding range of human physiological development; and
wherein for each critical dimension, the first pillow has a minimum dimension, the last pillow has a maximum dimension, and the other pillows in the set have distinct dimensions that form graduated increments in the critical dimension over the set from said minimum dimension to said maximum dimension.

2. The graduated set of pillows of claim 1, wherein each of the graduated increments increases the critical dimension over the set by an approximately constant value.

3. The graduated set of pillows of claim 1, wherein at least one of the plurality of critical dimensions of each pillow is dependent on at least one of the height, weight, head circumference, length of vertebral column, and neck circumference of an average person within a particular range of human physiological development.

4. The graduated set of pillows of claim 1, wherein each pillow is configured for a particular range of ages.

5. The graduated set of pillows of claim 4, wherein the plurality of pillows comprises at least 4 pillows, a first pillow configured for a range of ages from 2 to 4, a second pillow configured for a range of ages from 5 to 7, a third pillow configured for a range of ages from 8 to 11, and a last pillow configured for a range of ages from 12 to 15.

6. The graduated set of pillows of claim 1, wherein each pillow has a central section with a substantially flat upper surface for cranial support and at least one end section, adjacent to said central section, with a substantially arcuate upper surface for spinal support, and wherein the plurality of critical dimensions of each pillow comprises a central section thickness, a central section width, a central section length, an end section thickness relative to the most upper surface of the substantially arcuate upper surface, an end section width, and an end section length.

7. The graduated set of pillows of claim 6, wherein the central section thickness is approximately 2.0 inches (51 mm) for the first pillow and approximately 2.6 inches (66 mm) for the last pillow, the central section width is approximately 4.5 inches (114 mm) for the first pillow and approximately 6 inches (153 mm) for the last pillow, each of the central section length and the end section length is approximately 15 inches (381 mm) for the first pillow and approximately 19.5 inches (495 mm) for the last pillow, the end section thickness is approximately 2.2 inches (56 mm) for the first pillow and approximately 3.4 inches (86 mm) for the last pillow, and the end section width is approximately 2.5 inches (64 mm) for the first pillow and approximately 4.3 inches (109 mm) for the last pillow.

8. The graduated set of pillows of claim 6, wherein the first pillow has a central section thickness of approximately 2.0 inches (51 mm) and the other pillows in the set have distinct central section thicknesses that form graduated increments of approximately 0.2 inches (5 mm) over the set, the first pillow has a central section width of approximately 4.5 inches (114 mm) and the other pillows in the set have distinct central section widths that form graduated increments of approximately 0.5 inches (13 mm) over the set, the first pillow has a central section length and an end section length each of approximately 15 inches (381 mm) and the other pillows in the set have distinct central section lengths and end section lengths that each form graduated increments of approximately 1.5 inches (38 mm) over the set, the first pillow has an end section thickness of approximately 2.2 inches (56 mm) and the other pillows in the set have distinct end section thicknesses that form graduated increments of approximately 0.4 inches (10 mm) over the set, and the first pillow has an end section width of approximately 2.5 inches (64 mm) and the other pillows in the set have distinct end section widths that form graduated increments of approximately 0.6 inches (15 mm) over the set.

9. The graduated set of pillows of claim 1, wherein each pillow comprises a particular type of viscoelastic memory foam, wherein each pillow has a central section with a substantially flat upper surface for cranial support, wherein at least one of the plurality of critical dimensions of each pillow includes a central section thickness, and wherein the central section thickness is dependent on the cranial weight of an average person within a particular range of human physiological development and the compression characteristics of said particular type of viscoelastic memory foam.

10. The graduated set of pillows of claim 1, wherein each pillow is enclosed with a dust mite resistant cover that is treated with an antimicrobial technology.

11. The graduated set of pillows of claim 10, wherein the dust mite resistant cover comprises a zippered polyester fabric which has been laminated with polyurethane, and wherein the antimicrobial technology comprises Aegis Microbe Shield® antimicrobial technology.

12. A method of manufacturing a graduated set of pillows, comprising:
manufacturing a plurality of three or more pillows, configuring each pillow for a particular range of human physiological development, including a first pillow configured for a first range of human physiological development and a last pillow configured for a last range of human physiological development;
configuring each pillow to have a plurality of critical dimensions targeting the corresponding range of human physiological development; and
for each critical dimension, configuring the first pillow to have a minimum dimension, the last pillow to have a maximum dimension, and the other pillows in the set to have distinct dimensions that form graduated increments in the critical dimension over the set from said minimum dimension to said maximum dimension.

13. The method of claim 12, wherein each of the graduated increments increases the critical dimension over the set by an approximately constant value.

14. The method of claim 12, wherein configuring each pillow to have a plurality of dimensions comprises configuring at least one of the plurality of dimensions to be dependent on at least one of the height, weight, head circumference, length of vertebral column, and neck circumference of an average person within a particular range of human physiological development.

15. The method of claim 12, wherein configuring each pillow for a particular range of human physiological development comprises configuring each pillow for a particular range of ages.

16. The method of claim 15, wherein manufacturing a plurality of pillows, configuring each pillow for a particular range of human physiological development comprises manufacturing at least 4 pillows, configuring a first pillow for a range of ages from 2 to 4, configuring a second pillow for a range of ages from 5 to 7, configuring a third pillow for a range of ages from 8 to 11, and configuring a last pillow for a range of ages from 12 to 15.

17. The method of claim 12, further comprising configuring each pillow to have a central section with a substantially flat upper surface for cranial support and at least one end section, adjacent to said central section, with a substantially arcuate upper surface for spinal support, and wherein configuring each pillow to have a plurality of dimensions comprises configuring each pillow to have a central section thickness, a central section width, a central section length, an end section thickness relative to the most upper surface of the substantially arcuate upper surface, an end section width, and an end section length.

18. The method of claim 17, wherein for each dimension, configuring the first pillow to have a minimum dimension and configuring the last pillow to have a maximum dimension comprises configuring the central section thickness to be approximately 2.0 inches (51 mm) for the first pillow and approximately 2.6 inches (66 mm) for the last pillow, the central section width to be approximately 4.5 inches (114 mm) for the first pillow and approximately 6 inches (153 mm) for the last pillow, each of the central section length and the end section length to be approximately 15 inches (381 mm) for the first pillow and approximately 19.5 inches (495 mm) for the last pillow, the end section thickness to be approximately 2.2 inches (56 mm) for the first pillow and approximately 3.4 inches (86 mm) for the last pillow, and the end section width to be approximately 2.5 inches (64 mm) for the first pillow and approximately 4.3 inches (109 mm) for the last pillow.

19. The method of claim 17, wherein for each dimension, configuring the first pillow to have a minimum dimension and configuring the other pillows in the set to have distinct dimensions that form graduated increments in the critical dimension over the set comprises configuring the first pillow to have a central section thickness of approximately 2.0 inches (51 mm) and the other pillows in the set to have distinct central section thicknesses that form graduated increments of approximately 0.2 inches (5 mm) over the set, the first pillow to have a central section width of approximately 4.5 inches (114 mm) and the other pillows in the set to have distinct central section widths that form graduated increments of approximately 0.5 inches (13 mm) over the set, the first pillow to have a central section length and an end section length each of approximately 15 inches (381 mm) and the other pillows in the set to have distinct central section lengths and end section lengths that each form graduated increments of approximately 1.5 inches (38 mm) over the set, the first pillow to have an end section thickness of approximately 2.2 inches (56 mm) and the other pillows in the set to have distinct end section thicknesses that form graduated increments of approximately 0.4 inches (10 mm) over the set, and the first pillow to have an end section width of approximately 2.5 inches (64 mm) and the other pillows in the set to have distinct end section widths that form graduated increments of approximately 0.6 inches (15 mm) over the set.

20. The method of claim 12, further comprising manufacturing each pillow with a particular type of viscoelastic memory foam and configuring each pillow to have a central section with a substantially flat upper surface for cranial support, and wherein configuring each pillow to have a plurality of dimensions comprise configuring each pillow to have a central section thickness, the central section thickness dependent on the cranial weight of an average person within a particular range of human physiological development and the compression characteristics of said particular type of viscoelastic memory foam.

21. The method of claim 12, further comprising enclosing each pillow with a dust mite resistant cover and treating the dust mite resistant cover with an antimicrobial technology.

22. The method of claim 21, wherein the dust mite resistant cover comprises a zippered polyester fabric which has been laminated with polyurethane, and wherein the antimicrobial technology comprises Aegis Microbe Shield® antimicrobial technology.
